(19) United States
(12) Patent Application Publication
(10) Pub. No.: US 2009/0282228 A1
(43) Pub. Date: Nov. 12, 2009

(54) Automated Selection of Computer Options

(75) Inventors: Jane Childs, Epping (AU); Paul Roller Michaelis, Louisville, CO (US); Ted Saoumi, Georges Hall (AU); Richard Windhausen, Boulder, CO (US)

Correspondence Address: AVAYA INC.;MARGARET CARMICHAEL, DOCKETING SPECIALIST, 1300 W. 120TH AVENUE, ROOM B1-F53, WESTMINSTER, CO, 80234, US

(73) Assignee: AVAYA INC., Basking Ridge, NJ (US)

(21) Appl. No.: 12/115,939

(22) Filed: May 6, 2008

(51) Int. Cl. G06F 9/06

(52) U.S. Cl. 713/1

(57) ABSTRACT

A user of a computer indicates a desired user interface behavior, and the computer automatically selects and sets options of programs and devices of the computer individually for each program to achieve that behavior. Alternatively, the user indicates a condition of the user, such as a specific motor or sensory disability, and the computer automatically adjusts its programs and devices to accommodate the user's needs.

### TECHNICAL FIELD

This invention relates to selecting preferences and setting options in computers and other programmable entities.

### BACKGROUND OF THE INVENTION

Computer users may customize user interfaces presented by programs, and these preferences may be saved so that the preferred interface style will be presented if the program is closed and then reopened. For example, user-adjustable settings that are supported by the telnet.exe terminal emulation program include the font, the size of the font, the foreground color and the background color. Or, Internet browsers allow users to specify operational and display references that are then applied to every web page.

Operating systems use configuration files to store information and settings for hardware and software. For example, the MS DOS and early versions of the Windows operating systems use .INI files—text organized in a simple format that can be read and written using special routines available to programs. A SYSTEM.INI file is used for all internal settings. A WIN.INI file is used for user preferences. Also, each application has an .INI file, usually named after itself.

To tidy up the profusion of per-program .INI files and the difficulty of tracking them all, later versions of the Windows operating system replaced .INI files with a Registry. A Windows Registry is a central directory that stores all the settings and options for the system. It contains information and settings for all the hardware, operating system software, most non-operating system software, users, preferences of the computer, etc. For example, whenever a user makes changes to Control Panel settings, file associations, system policies, or most installed software, the changes are reflected and stored in the Registry.

Other operating systems use separate configuration files for separate application subsystems, but group them together for ease of management.

Although configuration files enable per-user per-program preferences to be set, current practice requires that each preference that differs from predefined default settings be manually entered separately by each user for each hardware or software entity. Not only is this tedious, but it also requires a fairly-sophisticated knowledge of the computer by the user—a knowledge that at least some users of the computer may not possess.

People with disabilities often take advantage of the options-setting functionality of operating systems in order to accommodate their disability. For example, individuals with cataracts may find that black text against a white background is difficult to see on a computer screen, and so they will set their display preference in their word-processing program, such as Microsoft Word, to bold white font against a black background in order to make displayed text more legible. Unfortunately, making this change will cause the document to be printed with those settings. For this reason, a preferred approach may be to choose the “Accessibility” option of the Microsoft Windows operating system, and then select “Magnifier” and “Reverse Video” options. This will affect the computer display without changing the document or the appearance of the print-out.

A problem with this approach is that the system-wide display settings are applied to all programs, which in some cases results in the settings being applied inappropriately. For example, if “Reverse Video” is selected, a document that has white text on a black background (which is the desired view in the example presented above) will now be undesirably displayed as black text against a white background. Or, if a person with poor vision uses the “Magnifier” option to select a certain magnification to increase small font size, that magnification will be applied to all programs, including those that do not use a small font size. Therefore, if the system-wide settings are wrong, a user must reset the preferences manually for each program.

A complicating factor is that the U.S. Code of Federal Regulations, 36C.F.R. Part 1194.21(b), prohibits individual programs from overriding display preferences that have been set via a system-wide accessibility feature. This effectively bans the use of program-specific or document-specific display preferences if a system-wide accessibility preference has been activated.

### SUMMARY OF THE INVENTION

According to one aspect of the invention, system preferences are specified by the desired outcome (irrespective of what actions or lack of action it takes to achieve the outcome) and options are automatically selected and set to achieve the desired outcome. For example, rather than specifying “Reverse Video,” a person with cataracts is enabled to specify “always show white or yellow text against a black background.” Or, rather than specifying “3× magnification,” a person with poor eyesight is enabled to specify “make text a preferred font and large enough to be legible.” The system compares the desired outcome against the characteristics of target devices, programs, or documents, and if a mismatch is detected, the system automatically determines what modification to the characteristics is needed to produce the desired outcome and then automatically modifies the characteristics accordingly. Illustratively, the system performs this activity for each entity in real-time when the entity is invoked or opened. Alternatively, the system performs this activity on a per-program basis when a user invokes the program, and it automatically adjusts settings in the Registry or .INI files for that program.

According to a further aspect of the invention, a user specifies a characteristic of the user as opposed to of the system—such as a particular disability, for example—and the system automatically determines the desired system outcomes for that characteristic. For example, if the user specifies “macular degeneration” as a user characteristic, the system determines “make text a preferred font and large enough to be legible” as a desired outcome. Or, if the user specifies “keyboard compatibility with documents” as a desired outcome, opening of an English-language document or accessing of a web page that does not have a country designation causes a US keyboard layout to be enabled, whereas opening of a German language document or accessing a web page with a .de designation causes a German keyboard layout to be enabled.

As used herein, “automatically” means the opposite of “manually,” that is, by machine without human involvement.

### BRIEF DESCRIPTION OF THE DRAWING

These and other features and advantages of the invention will become more apparent from considering the following description of an illustrative embodiment of the invention together with the drawing, in which:

FIG. 1 is a block diagram of a system that includes an illustrative embodiment of the invention;

FIG. 2 is a block diagram of an options-setting data table of the system of FIG. 1; and

FIG. 3 is a flowchart of operation of an options-setting process of the system of FIG. 1.

### DETAILED DESCRIPTION

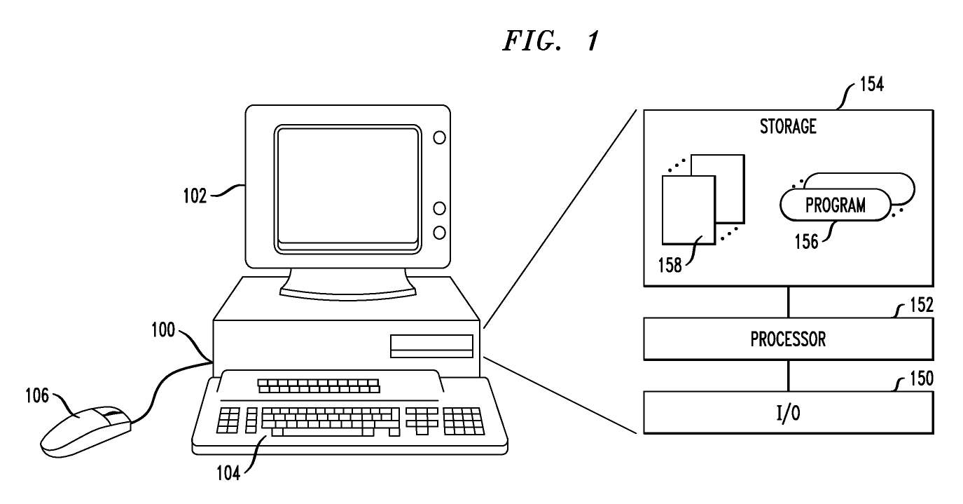

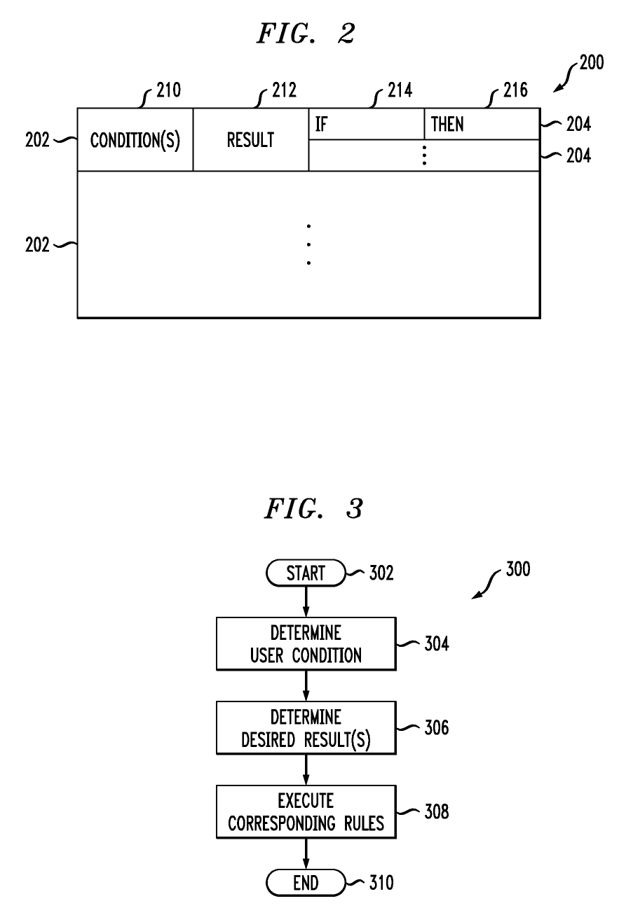

FIG. 1 shows an illustrative stored-program-controlled system 100. System 100 can be any desired system, such as a computer, a workstation, a personal digital assistant, a wireless telephone, a gaming device, etc. As is common, system 100 comprises storage 154 for storing programs 156 and data 158, a processor 152 for executing programs 156 and generating and/or using data 158, and an input and output interface (I/O) 150 for interacting with other devices. As shown, system 100 includes entities for interacting with users, such as a keyboard 104, a cursor-control device such as a mouse 106, and a display screen 102. I/O 150 interfaces devices 101-106 with processor 152. Programs 156 illustratively include application programs, such as a word processor and a web browser. Data 158 illustratively include text documents and images, as well as configuration data.

As described so far, system 100 is conventional.

According to an illustrative embodiment of the invention, data 158 include data that is used by processor 152 for setting system options, which data illustratively takes the form of a table 200 that comprises one or more entries 202. Each entry 202 corresponds to a different outcome that may be achieved by option setting. The outcome is specified in field 212 of entry 202. Each outcome corresponds to zero or more user conditions for which this outcome is desirable. These conditions are listed in a list of conditions 210 of entry 202. Each outcome may be achieved by following one or more rules which form sub-entries 204 of entry 202. Each rule illustratively takes for form of an “if-then” statement, wherein the “then” portion of the rule, stored in field 216 of sub-entry 204, specifies what action is to be taken when the present conditions of the system are as indicated by the “if” portion of the rule, stored in field 214 of sub-entry 204. Illustratively, table 200 takes the form of an Extensible Mark-Up Language (XML) file.

Although a text-based approach like XML that is parsed by a standardized, cross-platform, interpreter is good for generalized applicability, the interpreted format may need to be converted to a form that runs on and impacts the choices of the specific platform in question. This may be effected by a program that collects the conditions and rules and then adapts and manages that for the particular platform. The actual format of the table, and the representation of the data, may be individualized for the particular platform on which it is being used, although the user interface of the program is preferably standard, and may be similar to that of web browsers.

Below are some illustrative entries 202 that could be employed in system 100 (with an indication of the problem and the prior art in parentheses):

(Problem: Cataracts are a clouding of the lens inside the eye. On a back-lit computer screen, black text against a bright white background can be difficult to see.)

(Prior Art: “Reverse Video” is Allowable as a Global Preference.)

Condition: Cataracts

Outcome: Always show white or yellow text against a black background.

Rules:
(1) If the format of the original user interface is black text on a white background, then convert the display automatically to white-on-black or yellow-on-black.
(2) If the format of the original interface is white or yellow text on a black background, then make no changes to the display.

(Problem: Macular degeneration is a deterioration of the retina that reduces people's ability to see small details. At normal viewing distances, text below a certain size is not legible. Sans-serif fonts, such as Arial, Helvetica, and Verdana, are better for people with low vision.)

(Prior art: Screen magnification software that makes everything larger.)

Condition: Macular degeneration

Outcome: Make text a preferred font and large enough to be legible.

Rules:
(1) If the original user interface does not use a sans-serif font, convert the text to sans-serif.
(2) If the original user interface uses a sans-serif font, do not change the font.
(3) If the size of the text in the user interface is less than X points, increase it to X points.
(4) If the size of the text in the interface is less than X points and cannot be changed, then use text-to-speech conversion to voice the text.
(5) If the size of the text in the user interface is equal to or greater than X points, do not change its size.

(Problem: For people who are moderately hard-of-hearing, speech from electronic sources at normal levels of amplification can be heard but is hard to understand. In most cases, this is because the low-amplitude components of human speech, notably unvoiced fricatives, such as “F” and “S”, and unvoiced plosives, such as “P” and “T”, are below the listener's hearing threshold.)

(Prior art: Amplification techniques that make everything louder by the same amount. “Method and apparatus for improving the intelligibility of digitally compressed speech”, U.S. Pat. No. 6,889,186, can introduce unacceptable levels of distortion when applied to non-speech signals, such as music.)

Condition: Moderate hearing loss

Outcome: Enhance speech signals to improve their intelligibility.

Rules:
(1) If the original audio signal is speech, then apply an intelligibility-improving algorithm.
(2) For all audio signals, speech and non-speech, engage an automatic gain control mechanism to ensure that the output levels are consistent across applications, regardless of the amplitude of the original source.

(Problem: State of keyboard Caps Lock key applies to all applications)

(Prior art: Once pressed, the Caps Lock key state is dominant for all applications. The state remains active until the key is pressed again to turn Caps Lock off)

Condition: Text entry errors caused by inappropriate Caps Lock setting.

Outcome: “context-based Caps Lock”
Rules: (1) If Cap Lock key is not pressed in current application, then ignore Caps Lock key state.
(2) If the cursor is located in a word or field in which all characters are upper-case, then engage Caps Lock.
(3) If the cursor is located in a word or field in which at least some characters are lower-case, then disengage Caps Lock.
(4) If the cursor is located in a “login name” or “password” field, then disengage Caps Lock.

(Problem: Play-along game that enables a game player to simulate playing of a bass guitar along with selected song requires a manual change of guitar from left-handed to right-handed play to play along with a left-handed artist such as Paul McCartney.)

Condition: none

Outcome: change hand with artist

Rules: (1) If music is by The Beatles, then switch guitar play from right-handed to left-handed.

Illustratively, table 200 may be provided with predefined (default) entries 202. These entries 202 may then be modified by a user and/or may be supplemented by the user or by an administrator with additional entries 202.

According to an illustrative embodiment of the invention, programs 156 include an options setting program 300, shown in FIG. 3. Program 300 is invoked, at step 302, whenever a user logs into system 100 and whenever a change is made to contents of table 200. In response, processor 152 attempts to determine a condition, if any, of the user, at step 304. For example, processor 152 queries the user for a condition via display 102. In response to determining a condition, processor 152 uses table 200 to determine the corresponding desired outcomes, at step 306. Alternatively, if no condition is determined at step 304, the processor queries the user to determine any desired outcomes, at step 306. Once the desired results are known, processor 152 executes the rules that correspond to the desired outcomes, at step 308. The execution of the rules may require continuous running of program 300 in the background so that requisite actions are taken at appropriate times. For example, the rules associated with the “no Caps Lock” result must be executed each time the user switches between application programs. Execution of program 300 ends, at step 310, when the user logs off or contents of table 200 are changed.

Of course, various changes and modifications to the illustrative embodiment described above will be apparent to those skilled in the art. For example, the options-selection arrangement can be applied to a wide spectrum of input and output devices, game systems, mobile devices, configuration shifts (e.g., portrait/landscape print mode, different tablet-PC behaviors, keyboard/voice/drawing pad interface, single/multiple screen view, cell phone/computer behavior), detection of diacritical marks to effect keyboard changes, etc. Or, if someone's name contains a special character (e.g., Ø), the use case may be automatic detection of entering a Name field of a form or a document and in response automatically configuring the keyboard to a mode that allows entry of the special character. Such changes and modifications can be made without departing from the spirit and the scope of the invention and without diminishing its attendant advantages. It is therefore intended that such changes and modifications be covered by the following claims except insofar as limited by the prior art.

What is claimed is:

1. A method of setting options in a programmable system, comprising:
determining an outcome desired by a user of the system; and
in response to the determining, automatically selecting and setting options individually for each of a plurality of programs of the system to achieve the outcome.

2. The method of claim 1 wherein:
determining an outcome comprises
selecting one of a plurality of possible outcomes selectable by the user.

3. The method of claim 1 wherein:
determining an outcome comprises
determining a condition of the user, and
in response to determining the condition, automatically determining at least one outcome that corresponds to the condition.

4. The method of claim 3 wherein:
determining a condition of the user comprises
selecting one of a plurality of possible conditions selectable by the user.

5. The method of claim 1 wherein:
automatically selecting and setting options comprises
automatically executing rules that correspond to the outcome.

6. The method of claim 1 further comprising:
in response to the determining, automatically selecting and setting options of at least one device of the system individually for each of the programs to achieve the outcome.

7. An apparatus for setting options in a programmable system, comprising:
means for determining an outcome desired by a user of the system; and
means responsive to the determining, for automatically selecting and setting options individually for each of a plurality of programs of the system to achieve the outcome.

8. The apparatus of claim 7 wherein:
the means for determining an outcome comprises
means for a user to indicate selection of one of a plurality of possible outcomes selectable by the user.

9. The apparatus of claim 7 wherein:
the means for determining an outcome comprises
means for determining a condition of the user, and
means responsive to determining of the condition, for automatically determining at least one outcome that corresponds to the condition.

10. The apparatus of claim 9 wherein:
the means for determining a condition comprise
means for a user to indicate selection of one of a plurality of possible conditions selectable by the user.

11. The apparatus of claim 7 wherein:
the means for automatically selecting and setting options comprise
means for automatically executing rules that correspond to the outcome.

12. The apparatus of claim 7 wherein:
the means for automatically selecting and setting are adapted to automatically select and set options of at least one device of the system individually for each of the programs to achieve the outcome.

13. An apparatus for setting options in a programmable system, comprising:
storage for storing information that identifies an outcome desired by a user of the system;
storage for storing a program that uses the information to automatically select options individually for each of a plurality of programs of the system to achieve the outcome; and
a processor for executing the program.

14. The apparatus of claim 13 wherein:
the storage for storing information is for storing information for a plurality of possible outcomes; and
the apparatus further comprises
an interface for enabling the user to select one of the plurality of possible outcomes.

15. The apparatus of claim 13 wherein:
the storage for storing information is further for storing information that identifies a condition of the user and at least one outcome corresponding to the condition; and
the program is adapted to use the information that identifies the condition to determine the corresponding at least one outcome, and is adapted to use the determination of the at least one outcome to automatically select and set options individually for each of the programs to achieve the determined at least one outcome.

16. The apparatus of claim 15 wherein:
the storage for storing information is for storing information for a plurality of possible conditions; and
the apparatus further comprises
an interface for enabling the user to select one of the plurality of conditions.

17. The apparatus of claim 13 wherein:
the storage for storing information is adapted to store rules corresponding to the outcome; and
the program is adapted to execute the rules that correspond to the outcome.

18. The apparatus of claim 13 wherein:
the program is adapted to automatically select and set options of at least one device of the system individually for each of the programs to achieve the outcome.
